(19) United States
(12) Patent Application Publication
(10) Pub. No.: US 2016/0323244 A1
(43) Pub. Date: Nov. 3, 2016

(54) SECURE REPORTING OF EVENTS

(71) Applicant: Telemetry Limited, London (GB)

(72) Inventors: Geo CARNCROSS, London (GB); Russell IRWIN, London (GB); Beau Ner CHESLUK, London (GB); Anthony RUSHTON, West Byfleet (GB)

(21) Appl. No.: 14/702,519

(22) Filed: May 1, 2015

(51) Int. Cl. H04L 29/06; H04L 12/58; G06Q 30/02; H04L 29/08

(52) U.S. Cl. CPC H04L 63/029; H04L 67/02; H04L 51/22; G06Q 30/0277; H04L 63/0428

(57) ABSTRACT

A method of securely reporting events on a computing device comprising a web browser, the method comprising providing a loader to the computing device and the loader providing a wrapper to the web browser for execution by the web browser, wherein the wrapper is a closure. The loader establishing a secure communication path from the loader to the wrapper, and a secure communication path from the wrapper to the loader. The wrapper establishing an inline frame “IFrame” within the web browser, wherein the IFrame comprises a universal resource locator which points to a kernel. Establishing a firewall around the IFrame. Establishing a secure communication path from the wrapper to the kernel. Establishing a secure communication path from the kernel to the wrapper. Providing an event reporter to the IFrame through the loader, wrapper and kernel using the established secure communication paths from the loader to the wrapper and from the wrapper to the kernel, and running the event reporter in the IFrame.

### TECHNICAL FIELD

The present invention relates to methods for secure reporting of events, and in particular to secure reporting of events on a computing device.

### BACKGROUND

A significant proportion of the media consumed by the public is viewed and/or heard by users on electronic devices such as desktop computers, laptops, netbooks, tablets, smartphones, and the like, through interfaces such as web browsers. As the number of electronic computing devices available to consumers has risen in recent years the proportion of media consumed by the public through an internet connection has increased, and is expected to continue to increase further in the future.

As a result, the placement of advertising to be provided through electronic computing devices over the internet, generally referred to as digital advertising, is of increasing interest.

In digital advertising, an advertiser or advertising agency will typically create advertising media, such as digital video and/or digital audio advertising content. This advertisement will then be distributed by a publisher who delivers the digital advertising content to web pages to be viewed and/or heard by a consumer. It is common for an advertiser to pay the publisher based on the number of instance of the digital advertising delivered, which may be the number of placements, or the number of impressions, that is the number of times that the placements are viewed.

In order to confirm that any advertising delivered to a consumer device has been viewed and/or heard by a consumer, in other words that it has been placed, reporting software is generally provided in association with the advertising. This reporting software may be integrated with the digital advertising, or may be packaged with the digital advertising. The reporting software monitors the delivery of the advertising and sends a report or reports regarding the progress of the delivery, the report may for example confirm that playing of the advertising started, was completed, and whether it was played in a form visible and/or audible to a human consumer. Typically, the reporting software is integrated or packaged with the advertising by the advertiser or advertising agency when they create the advertising, and sends the reports back to the advertiser or advertising agency so that the effective delivery of the advertising can be confirmed.

A problem with this approach is that unscrupulous publishers may use malicious software to modify or corrupt the reporting software to generate false reports of effective delivery of the associated advertising, in order to receive payments for deliveries of advertising which did not take place. There is evidence that this has been occurring in some cases.

The embodiments described below are not limited to implementations which solve this problem.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One aspect provides a method of providing a safe computing environment on a computing device using a closure. Event reporting software can then be executed in this safe computing environment.

An aspect of the disclosure provides a method of securely reporting events on a computing device comprising a web browser, the method comprising the steps of: providing a loader to the computing device; the loader providing a wrapper to the web browser for execution by the web browser, wherein the wrapper is a closure; the loader establishing a secure communication path from the loader to the wrapper and a secure communication path from the wrapper to the loader; the wrapper establishing an inline frame “IFrame” within the web browser, wherein the IFrame comprises a universal resource locator which points to a kernel; establishing a firewall around the IFrame; establishing a secure communication path from the wrapper to the kernel; establishing a secure communication path from the kernel to the wrapper; providing an event reporter to the IFrame through the loader, wrapper and kernel using the established secure communication paths from the loader to the wrapper and from the wrapper to the kernel; and running the event reporter in the IFrame.

In an aspect of the disclosure, the event reporter is arranged to send reports through the kernel, wrapper and loader using the established secure communication paths from the kernel to the wrapper and from the wrapper to the loader.

In an aspect of the disclosure, the event reporter is arranged to send reports regarding the delivery of an advertisement; and the method further comprises: providing an advertisement to the IFrame through the loader, wrapper and kernel using the established secure communication paths from the loader to the wrapper and from the wrapper to the kernel; and running the advertisement in the IFrame.

In an aspect of the disclosure, the event reporter and the advertisement are provided together.

In an aspect of the disclosure, the event reporter and the advertisement are provided integrally.

In an aspect of the disclosure, the event reporter is comprised in the advertisement.

In an aspect of the disclosure, the event reporter and the advertisement are provided separately.

In an aspect of the disclosure, the event reporter and the advertisement are provided from different sources.

In an aspect of the disclosure, the loader establishes a secure communication path from the wrapper to the loader by generating a plurality of callbacks comprising at least one true callback and a number of false callbacks, wherein the at least one true callback is embedded in the wrapper.

In an aspect of the disclosure, there is one true callback.

In an aspect of the disclosure, the loader is arranged to identify the use of any of the false callbacks as an attack on the security of the event reporter.

In an aspect of the disclosure, the loader establishes a secure communication path from the loader to the wrapper by providing a mailbox in the loader.

In an aspect of the disclosure, the loader is arranged to broadcast a mail notification message when there is mail in the mailbox, and the wrapper is arranged to respond to the mail notification message by using the true callback to access the mail in the mailbox.

In an aspect of the disclosure, the wrapper is arranged to use the true callback to check whether there is any mail in the mailbox in a time based manner.

In an aspect of the disclosure, the wrapper is arranged to use the true callback to check whether there is any mail in the mailbox periodically.

In an aspect of the disclosure, the firewall is established by the web browser.

In an aspect of the disclosure, the method is carried out when the web browser accesses a web page and the firewall separates the IFrame from the web page.

In an aspect of the disclosure, the secure communication path from the wrapper to the kernel is provided by the web browser.

In an aspect of the disclosure, when the IFrame is established, the kernel is provided with a public key of a public key-private key pair; and the secure communication path from the kernel to the wrapper is provided by the kernel encrypting messages using the public key and broadcasting the encrypted messages.

In an aspect of the disclosure, the wrapper is arranged to receive the broadcast encrypted messages and forward the broadcast encrypted messages to the loader using the secure communication path from the wrapper to the loader.

In an aspect of the disclosure, the loader comprises the private key of the public key-private key pair and is arranged to decode the encrypted messages.

In an aspect of the disclosure, the loader digitally signs messages to be sent to the kernel using the private key; and the kernel verifies the origin of the messages using the public key.

In an aspect of the disclosure, the public and private keys are RSA encryption keys.

In an aspect of the disclosure, elements provided to the computing device are provided through an interface.

In an aspect of the disclosure, the interface is a Video Player Ad-Serving Interface Definition (VPAID).

In an aspect of the disclosure, the firewall is arranged to permit the event reporter to send communications through the kernel and to prevent the event reporter from sending communications by other routes.

In an aspect of the disclosure, the firewall is arranged to prevent the advertisement from sending communications.

In an aspect of the disclosure, the event reporter sends reporting messages to an event reporting server.

In an aspect of the disclosure, the reporting messages are stored for subsequent analysis.

In an aspect of the disclosure, the stored reporting messages are analyzed to confirm whether or not an advertisement was delivered.

In an aspect of the disclosure, the stored reporting messages are subjected to statistical analysis to identify whether the stored reporting messages are subject to any statistical anomalies which suggest that the event reporters generating the reporting messages were executing in an emulated execution environment.

In an aspect of the disclosure, the statistical analysis comprises analyzing the identities of the IP address block owners from which the reporting messages are received.

In an aspect of the disclosure, the statistical analysis comprises identifying the operating systems producing the reporting messages.

In an aspect of the disclosure, elements provided to the computing device are provided through the Internet.

An aspect of the disclosure provides a computing device arranged to carry out a method of securely reporting events to the computing device comprising the steps of providing a loader to the computing device; the loader providing a wrapper to the web browser for execution by the web browser, wherein the wrapper is a closure; the loader establishing a secure communication path from the loader to the wrapper and a secure communication path from the wrapper to the loader; the wrapper establishing an inline frame “IFrame” within the web browser, wherein the IFrame comprises a universal resource locator which points to a kernel; establishing a firewall around the IFrame; establishing a secure communication path from the wrapper to the kernel; establishing a secure communication path from the kernel to the wrapper; providing an event reporter to the IFrame through the loader, wrapper and kernel using the established secure communication paths from the loader to the wrapper and from the wrapper to the kernel; and running the event reporter in the IFrame.

An aspect of the disclosure provides a computer program comprising computer readable instructions which, when executed by one or more processors, will cause the one or more processors to: provide a loader to the computing device; the loader providing a wrapper to the web browser for execution by the web browser, wherein the wrapper is a closure; the loader establishing a secure communication path from the loader to the wrapper and a secure communication path from the wrapper to the loader; the wrapper establishing an inline frame “IFrame” within the web browser, wherein the IFrame comprises a universal resource locator which points to a kernel; establish a firewall around the IFrame; establish a secure communication path from the wrapper to the kernel; establish a secure communication path from the kernel to the wrapper; provide an event reporter to the IFrame through the loader, wrapper and kernel using the established secure communication paths from the loader to the wrapper and from the wrapper to the kernel; and run the event reporter in the IFrame.

An aspect of the disclosure provides a method of providing a secure computing environment on a computing device comprising a web browser, the method comprising the steps of: providing a loader to the computing device; the loader providing a wrapper to the web browser for execution by the web browser, wherein the wrapper is a closure; the loader establishing a secure communication path from the loader to the wrapper and a secure communication path from the wrapper to the loader; the wrapper establishing an inline frame “IFrame” within the web browser, wherein the IFrame comprises a universal resource locator which points to a kernel; establishing a firewall around the IFrame; establishing a secure communication path from the wrapper to the kernel; establishing a secure communication path from the kernel to the wrapper.

An aspect of the disclosure provides a computing device arranged to carry out a method of: providing a loader to the computing device; the loader providing a wrapper to the web browser for execution by the web browser, wherein the wrapper is a closure; the loader establishing a secure communication path from the loader to the wrapper and a secure communication path from the wrapper to the loader; the wrapper establishing an inline frame “IFrame” within the web browser, wherein the IFrame comprises a universal resource locator which points to a kernel; establishing a firewall around the IFrame; establishing a secure communication path from the wrapper to the kernel; and establishing a secure communication path from the kernel to the wrapper.

An aspect of the disclosure provides a computer program comprising computer readable instructions which, when executed by one or more processors, will cause the one or more processors to: provide a loader to the computing device; the loader providing a wrapper to the web browser for execution by the web browser, wherein the wrapper is a closure; the loader establishing a secure communication path from the loader to the wrapper and a secure communication path from the wrapper to the loader; the wrapper establishing an inline frame “IFrame” within the web browser, wherein the IFrame comprises a universal resource locator which points to a kernel; establish a firewall around the IFrame; establish a secure communication path from the wrapper to the kernel; and establish a secure communication path from the kernel to the wrapper.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is an explanatory schematic diagram of known method of reporting delivery of advertising to a consumer device;

FIG. 2 is a flow diagram of a method of reporting events on a consumer device according to a first embodiment of the present invention;

FIG. 3 is a schematic diagram of an initial stage of the method of FIG. 2;

FIG. 4 is a schematic diagram of a subsequent stage of the method of FIG. 2; and

FIG. 5 is a schematic diagram of a final stage of the method of FIG. 2.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

In broad terms, the approach of the present invention is to provide a safe computing environment on a computing device. Event reporting software can then be executed in this safe computing space to provide assurance that reports from the reporting software have not been interfered with.

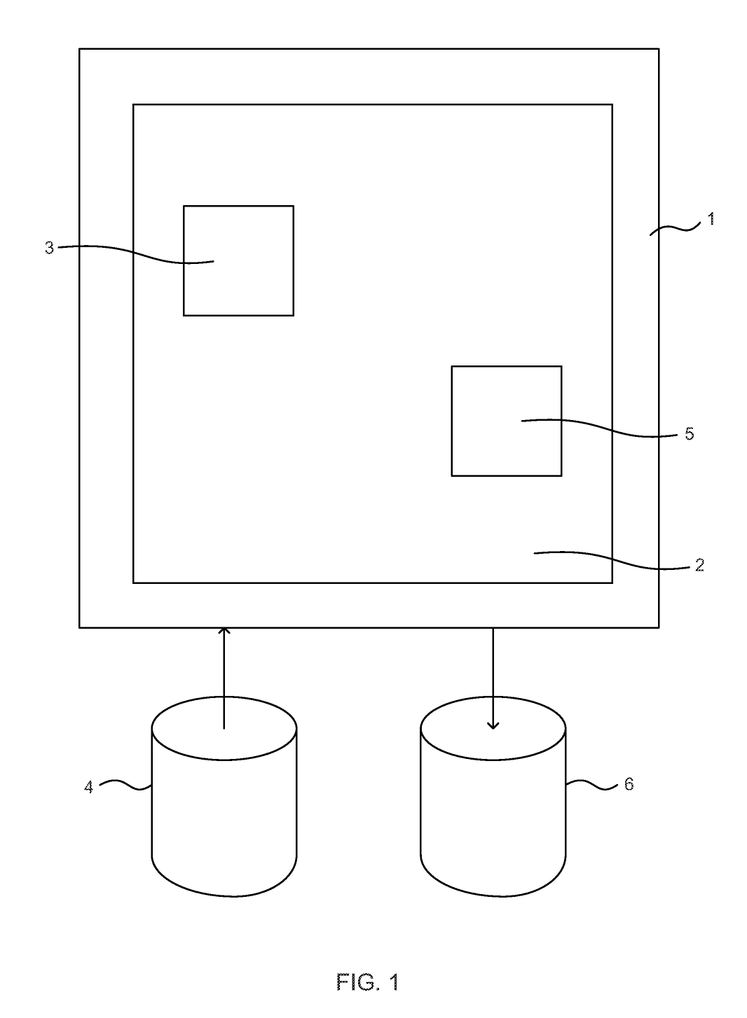

FIG. 1 shows a schematic diagram of the operation of reporting software associated with a digital advertisement.

In FIG. 1, a consumer device 1 supports a web browser 2. When the web browser 2 is used by a consumer to access a web page hosting digital advertising, a digital advertisement 3 is sent to the consumer device 1 by an advertising server 4 hosting digital advertising. The advertising server 4 also sends a sensor or event reporting program 5 together with the advertisement 3, and this event reporting program 5 is opened inside the web browser 2 to monitor the playing of the advertisement 3 in the web page displayed by the web browser 2. The event reporting program 5 may be sent in association with the advertisement 3, or may be embedded in the advertisement 3.

When the advertisement 3 is played in the web browser 2, the event reporting program 5 senses and monitors the progress of the advertisement 3 to identify events relating to the advertisement 3, and sends reports of the identified events to an advertiser reporting server 6. Subsequently, an advertiser can review the received reports stored by the advertising reporting server 6 and determine whether or not the advertisement 3 was successfully delivered. Payments to the entity placing the advertisement may then be made based on determinations of successful delivery of the advertisement 3, for example based on the number of placements or impressions of the advertisement 3.

A problem which may be encountered is that a malicious entity, such as an unscrupulous advertising publisher or other advertising placement company, could use a malicious program to interfere with the event reporting program 5 and arrange to send false reports of identified events to the advertising reporting server 6 so that the advertiser will be led to falsely believe that the advertisement 3 was successfully delivered when it was not.

Typically, in some examples the malicious program may replace the event reporting program 5 with a program which sends false reports indicating successful delivery of the advertisement 3, or edit the event reporting program 5 so that the event reporting program 5 always reports successful delivery of the advertisement 3. In some examples the malicious program may be sent together with the advertisement 3 and the event reporting program 5 to a genuine consumer device 1. These examples are not exhaustive.

It is difficult or impossible to prevent or detect the use of malicious programs to replace or edit the event reporting program so that false reports are sent because the consumer device 1 on which the advertisement 3 and the event reporting program 5 are executed is outside the control of the advertiser or advertising agency producing the advertisement 3 and the event reporting program 5.

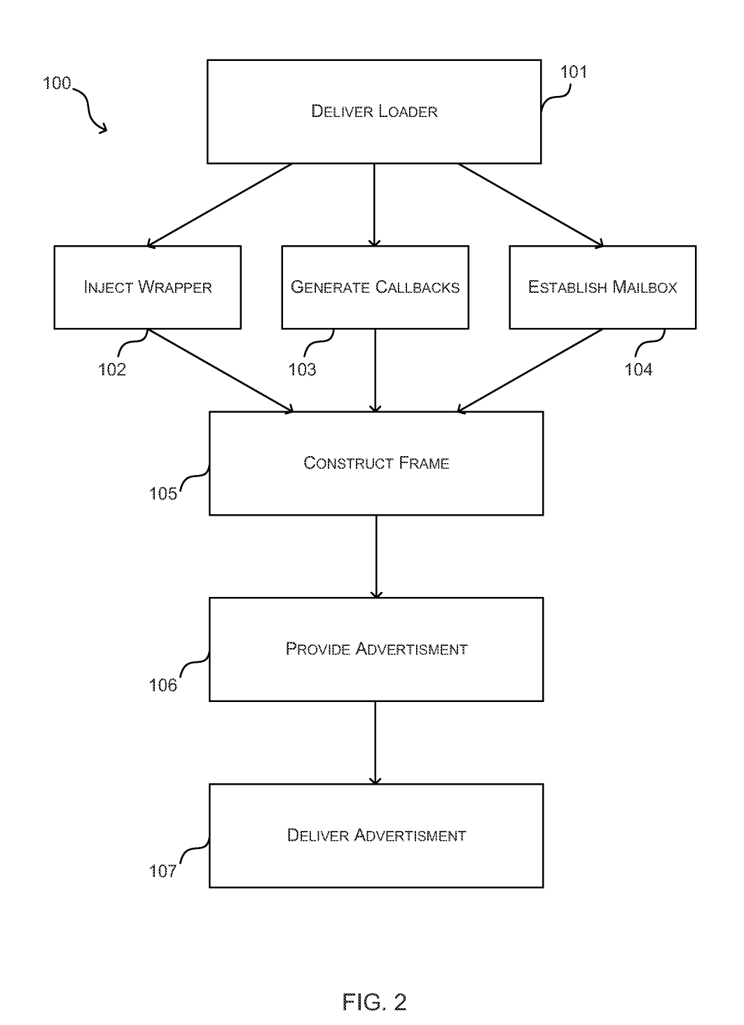

A first embodiment of the present invention will now be described with reference to FIGS. 2 to 5.

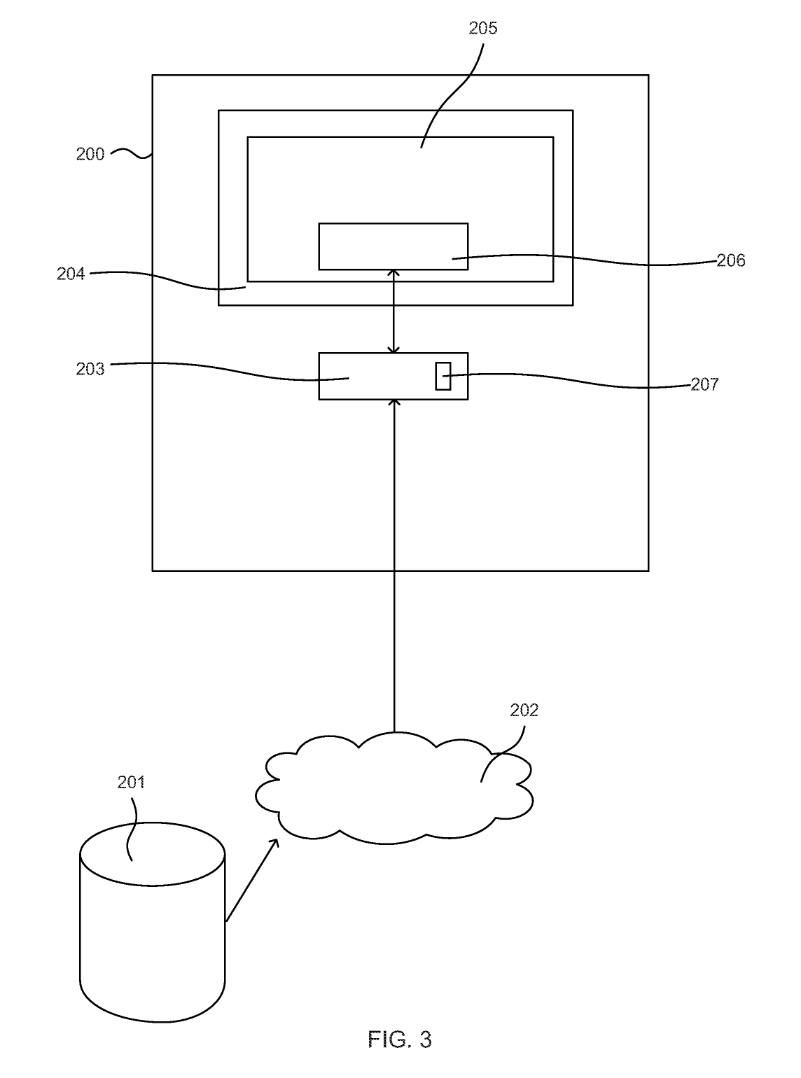

FIG. 2 shows a flow chart of a method 100 for reporting events. FIG. 3 is a schematic diagram showing a first part of the method.

FIG. 3 shows a consumer device 200 connected to an advertising publisher server 201 through the Internet 202. In some examples the consumer device 200 comprises one or more processors which execute instructions stored in a store or memory of the consumer device 200.

In a first loader delivery step 101 of the method 100, a loader 203 is delivered from the advertising publisher server 201 to the consumer device 200 viewing a web page 204 in a web browser 205. The loader 203 is sent from the advertising publisher server 201 and delivered to the consumer device 200 using a Video Player Ad-serving Interface Definition (VPAID) interface. VPAID is a commonly used protocol for providing digital advertising, and does not need to be described in detail herein.

The sending of the loader 203 may be carried out, for example, in response to a consumer using the web browser 205 of the consumer device 200 to view a web page 204 hosting advertising content.

Then, in an inject wrapper step 102, the loader 203 injects a wrapper 206 into the web page 204 displayed in the web browser 205 and the wrapper 206 is executed by the web browser 205.

The wrapper 102 is a closure. A closure is a block of computer code that closes over all of its inputs. Accordingly, a closure defines a function that has no free variables or arguments. As a result, when the wrapper 206 is executed by the web browser 205 the result of executing the wrapper 206 cannot be interfered with. In particular, the result cannot be interfered with by other programs on the consumer device 200.

Further, in a generate callbacks step 103 the loader 203 generates 100,000 different callbacks. One of these callbacks is a true callback and all of the other callbacks are false or trap callbacks. The generation of 100,000 callbacks is not essential. In other examples a different number of callbacks may be generated. As will be explained below it is desirable that a large number of callbacks are generated.

The name of the true callback is embedded in the wrapper 206 closure so that the name of the true callback is available to the wrapper 206. The loader 203 treats the use of any of the false trap callbacks as indicating that the consumer device 200 is a hostile computing environment. Accordingly, although any program on the consumer device 200 could use a callback to attempt to communicate with the loader 203 it is statistically unlikely that the true callback could be used purely by chance, and it is overwhelmingly likely that one of the false trap callbacks will be used instead. As a result, the use of the true callback name provides a secure communications path from the wrapper 205 to the loader 203.

Further, in an establish mailbox step 104, the loader 203 implements a mailbox 207 in the loader 203. The wrapper 206 can check the contents of the mailbox 207 within the loader 203 by using the true callback name, which, as explained above, is known to the wrapper 206.

It should be noted that the inject wrapper step 102, the generate callbacks step 103 and the establish mailbox step 104 may be carried out in any order, or may be carried out in parallel at the same time. All of these steps are carried out by the loader 203, and these different steps are not dependent on one another.

The loader 203 is then able to communicate securely with the wrapper 206 by placing a message in the mailbox 207 in the loader 203 and broadcasting a mail notification message indicating that there is mail in the mailbox 207 within the consumer device 200. When the wrapper 206 receives the broadcast mail notification, the wrapper 206 uses the true callback to access the mailbox 207 in the loader 203 and recover the message.

Although the broadcast mail notification could be received by a malicious program the broadcast mail notification does not include the actual message, but is merely an empty message indicating that the actual message has been placed in the mailbox 207. Accordingly, it is not possible for a malicious program to derive the actual message from the broadcast mail notification. Further, although a malicious program will be informed by the broadcast mail notification that a message for the wrapper 206 exists, any malicious program cannot obtain the actual message because it does not know the true callback allowing access to the mailbox 207 of the loader 203.

Accordingly, following the generation of the different callbacks in the generate callbacks step 103 and the establishment of the mailbox 207 in the establish mailbox step 104 the loader and wrapper can communicate securely in both directions.

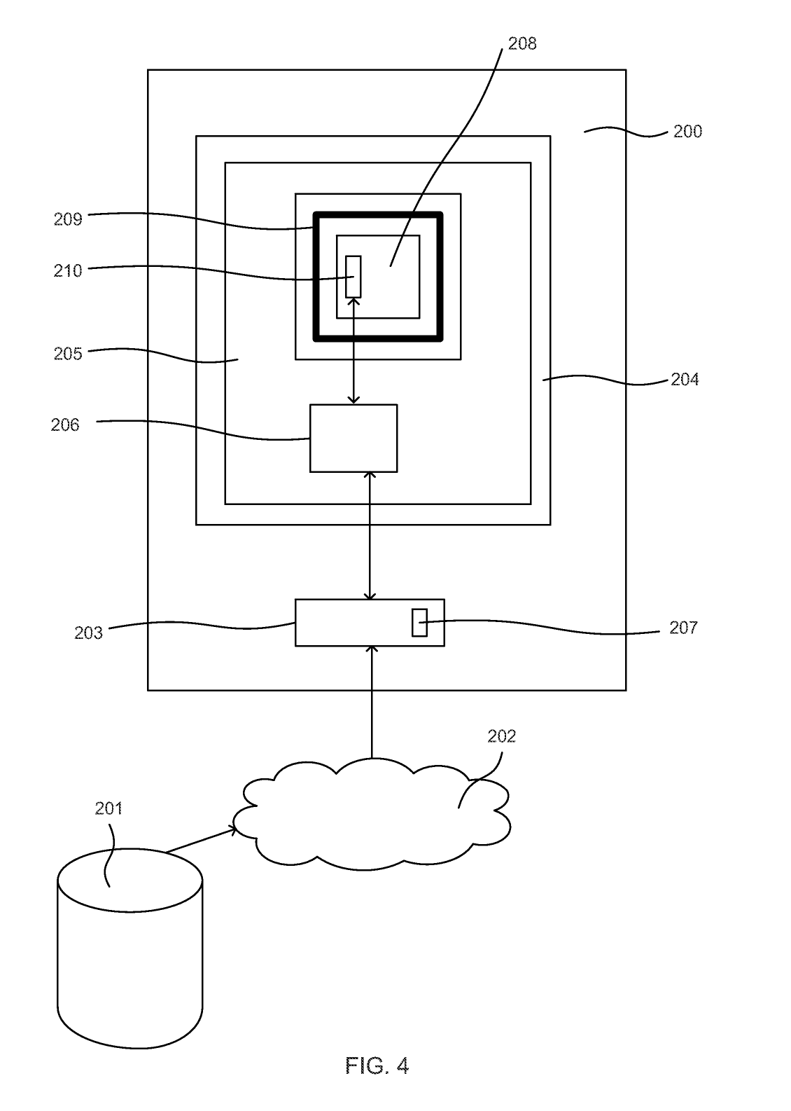

FIG. 4 is a schematic diagram showing a subsequent part of the method.

Next, in a construct frame step 105, the wrapper 206 constructs an Inline Frame (IFrame) 208 within the web page 205 being viewed in the web browser 204. The IFrame 208 is arranged to overlay the intended advertising placement location in the web page 205 in the web browser 204.

Browsers normally guarantee that different domains within the browser are not able to communicate with one another, with the exception that one domain can send a secure message to another domain opened within the one domain. Accordingly, the web browser 204 provides a firewall 209 protecting the IFrame 208, and separating the IFrame 208 from the web page 205. The web browser 204 provides a secret and secure messaging channel to the IFrame 208, but not from the IFrame 208.

The universal resource locator (URL) of the IFrame 208 points to a kernel program 210. When the IFrame 208 is established the kernel 210 receives a single URL argument for the IFrame 208, and this argument includes an RSA public key generated by the loader 203. The corresponding RSA private key is known to the loader 203. In some alternative examples the RSA public key may be passed to the Kernel 210 in other ways. In some alternative examples, another key pair based asymmetric cryptography system may be used instead of RSA.

As explained above, the web browser 205 does not provide a secure communications channel out of the IFrame 208. Accordingly, in order for the kernel 210 to communicate with the loader 203, the kernel 210 broadcasts a message encrypted using the RSA public key generated by the loader 203 within the consumer device 200.

The web browser 205 broadcasts any broadcast message sent from within the web browser 205 together with the source of the broadcast message. Accordingly, when the broadcast encrypted message from the kernel 210 is received by the wrapper 206, the wrapper 206 is able to verify that the encrypted message originated from the kernel 210. However, the wrapper 206 is not able to decrypt the received encrypted message. The wrapper 206 can then securely forward the received encrypted message to the loader 203 using the name of the true callback, as discussed above. When the encrypted message is received by the loader 203 through the true callback, the loader 203 is able to verify that the encrypted message was encrypted using the RSA public key provided to the kernel 210 and to decrypt the encrypted message from the kernel 210 using the RSA private key.

In order to communicate with the kernel 210, the loader 203 digitally signs messages for the kernel 210 using the RSA private key of the loader 203, then places the signed message in the mailbox 207 and broadcasts a mail notification. As discussed above, the wrapper 206 receives the broadcast mail notification and responds by accessing the signed message in the mailbox 207. The wrapper 206 identifies the signed message as a message for the kernel 210, and sends the signed message to the kernel 210 using the secure message channel supported by the web browser 204. When the kernel 210 receives the signed message, the kernel 210 can confirm that the signed message has been received from the wrapper 206 through the secure messaging channel supported by the web browser 204 and that it has been digitally signed by the loader 203 using the RSA private key. Accordingly, the kernel 210 can verify that the received signed message is genuine.

The IFrame 208 is protected by the firewall 209 provided by the web browser 204, and secure two way communications are provided to and from the IFrame 208, as is explained above. Accordingly, the IFrame 208 provides a secure computing environment.

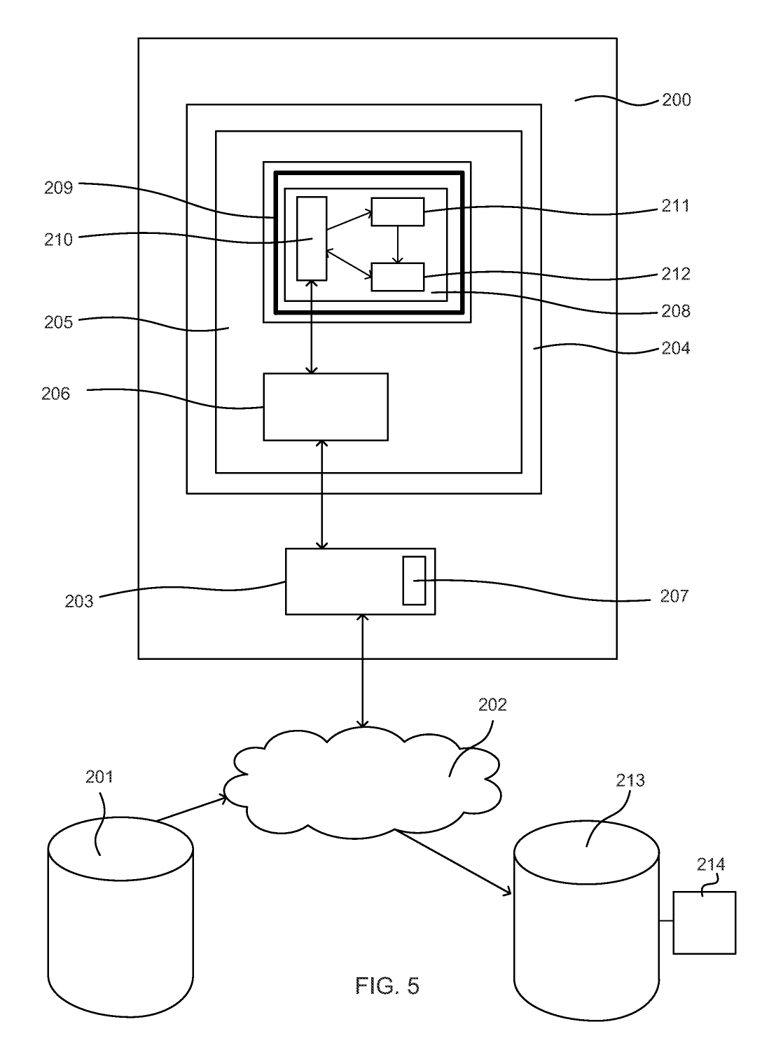

FIG. 5 is a schematic diagram showing a final part of the method.

After the IFrame 208 and kernel 210 have been established in the construct frame step 105 to form a secure computing environment, in a subsequent provide advertisement step 106 an advertisement 211 together with an associated event reporter program 212 is downloaded, or otherwise provided, to the consumer device 200 from the advertising server 201 using the VPAID interface. The advertisement 211 and the event reporter 212 may be separate, or they may integrated together, for example by the event reporter 212 being embedded in the advertisement 211.

The advertisement 211 and the event reporter 212 are digitally signed by the loader 203 using the RSA private key, and then sent from the loader 203 to the kernel 210 by being sent from the loader 203 to the wrapper 206 and then from the wrapper 206 to the kernel 210 using the secure communications methods described above. The kernel 210 then checks that the advertisement 211 and the event reporter 212 have been digitally signed by the loader 203.

The advertisement 211 and the event reporter 212 are then executed within the secure computing environment of the IFrame 208 in a deliver advertisement step 107. As the advertisement 211 is delivered the event reporter 212 monitors the progress of this delivery and generates and sends one or more progress reports to an advertising reporting server 213. The advertising reporting server 213 may be operated by the advertiser or advertising agency responsible for the advertisement 211, or may be operated by other interested parties such as an auditor, yield manager or ad exchange.

The kernel 210 presents a VPaid interface to the advertisement 211 and the event reporter 212. In some examples this may allow conventional advertisements and/or event reporting programs to be used with the disclosed method without any special preparation or modification being necessary. In some examples this may allow a standard advertisement and/or event reporter program to be used in a campaign both in combination with and without the present invention.

A progress report sent by the event reporter program 212 is initially sent to the kernel 210 using the VPaid interface presented by the kernel 210. The progress report is then encrypted by the kernel 210, and the encrypted progress report is broadcast as a broadcast message within the consumer device 200. This broadcast encrypted message from the kernel 210 is received by the wrapper 206, which verifies that the encrypted message originated from the kernel 210, and then securely forwards the received encrypted message to the loader 203 using the name of the true callback. This is the secure communications method described above.

The loader 203 verifies that the encrypted message was encrypted using the RSA public key provided to the kernel 210 and decrypts the encrypted message from the kernel 210 using the RSA private key to obtain the progress report. The loader 203 then sends the progress report to the advertising reporting server 213 using VPaid.

Where more than one progress report is to be sent regarding an advertisement the sending procedure is repeated for each progress report. In practice the number of progress reports sent during the execution of an advertisement to confirm delivery of the advertisement may vary, and may be any desired number of progress reports. The progress reports may, for example, confirm that delivery of the advertisement has started, or that the advertisement has paused, or that the advertisement has completed, or that the advertisement is visible when displayed, or the size of the displayed advertisement, or that the advertisement is audible when displayed. This list is given by way of example only, and is not intended to be exhaustive.

The progress reports are stored by the advertising reporting server 213 for review and/or analysis. The advertiser or advertising agency responsible for the advertisement 211, or other authorized parties, can review or analyze the stored reports and identify successful delivery of the advertisement 211. In some examples payments to the entity placing the advertisement, such as a publisher or other advertising placement company, may then be made based on determinations of successful delivery of the advertisement 3, for example based on the number of placements or impressions of the advertisement 3.

The identified instances of successful delivery of the advertisement 211 may then be used as a basis for assessing the fulfillment of contracts to place advertising, and may be the basis for making payments.

As is explained above the advertisement 211 and the event reporter program 212 execute inside the firewall 209, so that the advertisement 211 and the event reporter program 212 are protected from attack while executing. Further, the advertisement 211 and the event reporter program 212 are delivered along secure communication paths, and the progress reports from the event reporter program 212 are sent along secure communication paths. As a result, it is not possible for a malicious program to replace or edit the event reporter program 212 or to intercept and edit or replace the progress reports sent by the event reporter program 212.

Accordingly, the advertiser or advertising agency responsible for the advertisement 211 can be confident that progress reports received by the reporting server 213 and indicating successful delivery of the advertisement 211 are reliable.

Table 1 shows how each possible communication path between the different components are protected. Table 1 is laid out as a series of columns where each column corresponds to a different sending component, each row corresponds to a different receiving component, and the intersections identify the means protecting the communications. The sending components are identified at the tops of the columns and the receiving component is identified at the left end of each row. It will be understood that communications are not sent from a component to itself, so these intersections are left blank. Table 1 refers to the publisher. Any external entity could be substituted for the publisher in table 1. That is, the same means protect against all external entities including the publisher.

TABLE 1

| | | | | | Event |
|---|---|---|---|---|---|
| | Publisher | Loader | Wrapper | Kernel | reporter |
| Publisher | | VPaid | Not | RSA | Blocked by |
| | | | applicable | encrypted | firewall |
| | | | | broadcast | |
| Loader | Fake | | Real callback | RSA | Blocked by |
| | callbacks | | name | encrypted | firewall |
| | | | | broadcast | |
| Wrapper | No | Mailbox | | RSA | RSA |
| | accessible | | | encrypted | encrypted |
| | inputs | | | broadcast | broadcast |
| Kernel | Blocked by | RSA signed | RSA signed | | VPaid |
| | firewall | and verified | but unverified | | |
| | | message | message | | |
| Event | Blocked by | Blocked by | Blocked by | VPaid | |
| reporter | firewall | firewall | firewall | | |

In table 1 the possible communication path from the wrapper 206 to the publisher server 201 is marked as not applicable. Since the wrapper 206 is not intended to communicate with the publisher server 201, and the wrapper 206 is a closure, the wrapper 206 will never send messages to the publisher server 201.

It should be noted that, as shown in table 1, in addition to protecting the advertisement 211 and the event reporter program 212 from attack, the firewall 209 also prevents the event reporter program from accidentally communicating with anyone other than the advertising reporting server 213 through the correct secure route. Accordingly, the privacy of the consumer may be protected against any accidental leakage of information from the consumer device 200 by the advertisement 211 and the event reporter program 212.

In principle it could be possible for a malicious program to attempt to counter the present method by attempting to identify all of the callbacks generated by the loader 203 in the generate callbacks step 103, and replacing them with proxies that record activity in order to identify which one of the identified callbacks is the true callback.

The method described above can provide confidence that reported delivery of advertising has taken place when an advertisement is delivered to a consumer device.

One possible alternative method of producing false reports of delivery of advertising would be, instead of attempting to replace or edit the event reporter program, to allow the advertising and any associated reporting programs to execute on a computer system which, from the point of view of the advertising program executing on it, emulates or impersonates a consumer device. The advertising program and associated reporting programs would then produce apparently genuine reports indicating delivery of the advertising, although this would not really have taken place. For example, general purpose computer, such as a desktop PC or similar device, could run a large number of different instances of an advertisement and associated reporting software, and so generate a large number of reports of delivery of the advertising.

The method establishing a secure computing environment and secure communications discussed above would not prevent such impersonation, as the described method has no means to identify that it is running within an emulation of a consumer device supported by a different computing device.

In a further embodiment of the invention, in order to protect against emulation or imposture based attacks of this type the advertising reporting server 213 may be provided with a statistical analysis module 214.

The statistical analysis module 214 makes a statistical analysis of reports which have been received and compares these with models and historical data to identify any unusual and suspicious features of the received reports which may indicate that they have been mass produced using emulated web browsers and consumer devices instead of being produced by real consumers using real web browsers. In one example the IP address block owners from which the reports are received may be analyzed to confirm whether the apparent spread of different IP address block owners is statistically plausible. Additionally, or alternatively, the version, non-critical bugs, and other identifiable differences in operating systems can be used to fingerprint the operating systems producing the reports, and these statistics may be analyzed to confirm that the apparent range and number of types of operating systems is statistically plausible.

A number of statistical analysis techniques of this type are known, and any or all of these may be used in conjunction with the first embodiment described above to provide an increased level of certainty and security.

In the illustrated first embodiment described above, the loader 203 informs the wrapper 206 that there is mail in the mailbox 207 by sending a broadcast mail message. In an alternative embodiment the loader 203 does not send a broadcast mail message. Instead, the wrapper 206 checks the mailbox 207 to see whether or not there is a message in the mailbox 207. This check may be made periodically. In some examples the wrapper 206 may check the mailbox 207 every few milliseconds.

In the illustrated first embodiment described above the event reporter program 212 is provided to the consumer device 200 from the advertising server 201. In other examples the event reporter program 212 may be provided from another source. In some examples the event reporter program 212 may be provided from the advertiser, or an agent of the advertiser, such as an auditor.

In the illustrated first embodiment described above, the RSA public and private encryption keys are held by the loader 203. In some alternative examples these public and private keys may instead be provided by a server that has signed them using another public key. The kernel could then verify that the public key was properly signed before using it. This alternative may provide further improved security. In examples where a server provides the RSA private key, the server may do this by generating a web page representing the IFrame contents and containing the RSA public key.

The illustrated first embodiment described above communicates through the Internet. This is not essential. Other communications networks may be used.

The illustrated first embodiment described above uses the VPaid interface for communication. This is not essential. Other examples may use other interfaces.

The illustrated first embodiment described above uses RSA public key cryptography to encrypt and digitally sign messages. This is not essential. Other asymmetric public key and private key pair based cryptography systems may be used. Further, in some examples, other encryption and digital signing methodologies may be used.

The illustrated first embodiment described above receives the advertisement and associated reporter program from a publisher server 201. This publisher server 201 may be a server associated with the advertiser or advertising agency that has originated the advertisement. Alternatively, there may be any number of intermediate servers between the publisher server 201 and the ultimate source of the advertisement.

The embodiments described above relate to the secure reporting of events relating to the delivery of advertising. This is only an example. The present invention can also be applied to the secure reporting of other events.

The embodiments described above relate to the secure reporting of events relating to the delivery of advertising. This advertising may be in visible and/or audible form.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc and do not include propagated signals. The software can be suitable for execution on a parallel processor or a serial processor such that the method steps may be carried out in any suitable order, or simultaneously. This acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages.

Any reference to ‘an’ item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of preferred embodiments is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A method of securely reporting events on a computing device comprising a web browser, the method comprising the steps of:
providing a loader to the computing device;
the loader providing a wrapper to the web browser for execution by the web browser, wherein the wrapper is a closure;
the loader establishing a secure communication path from the loader to the wrapper and a secure communication path from the wrapper to the loader;
the wrapper establishing an inline frame “IFrame” within the web browser, wherein the IFrame comprises a universal resource locator which points to a kernel;
establishing a firewall around the IFrame;
establishing a secure communication path from the wrapper to the kernel;
establishing a secure communication path from the kernel to the wrapper;
providing an event reporter to the IFrame through the loader, wrapper and kernel using the established secure communication paths from the loader to the wrapper and from the wrapper to the kernel; and
running the event reporter in the IFrame.

2. The method according to claim 1, wherein the event reporter is arranged to send reports through the kernel, wrapper and loader using the established secure communication paths from the kernel to the wrapper and from the wrapper to the loader.

3. The method according to claim 1, wherein the event reporter is arranged to send reports regarding the delivery of an advertisement; and the method further comprising:
providing an advertisement to the IFrame through the loader, wrapper and kernel using the established secure communication paths from the loader to the wrapper and from the wrapper to the kernel; and
running the advertisement in the IFrame.

4. The method according to claim 3, wherein the event reporter and the advertisement are provided together.

5. The method according to claim 3, wherein the event reporter and the advertisement are provided separately.

6. The method according to claim 1, wherein the loader establishes a secure communication path from the wrapper to the loader by generating a plurality of callbacks comprising at least one true callback and a number of false callbacks, wherein the at least one true callback is embedded in the wrapper.

7. The method according to claim 6, wherein the loader is arranged to identify the use of any of the false callbacks as an attack on the security of the event reporter.

8. The method according to claim 1, wherein the loader establishes a secure communication path from the loader to the wrapper by providing a mailbox in the loader.

9. The method according to claim 8, wherein the loader is arranged to broadcast a mail notification message when there is mail in the mailbox, and the wrapper is arranged to respond to the mail notification message by using the true callback to access the mail in the mailbox.

10. The method according to claim 1, wherein the firewall is established by the web browser.

11. The method according to claim 1, wherein the method is carried out when the web browser accesses a web page and the firewall separates the IFrame from the web page.

12. The method according to claim 1, wherein the secure communication path from the wrapper to the kernel is provided by the web browser.

13. The method according to claim 1, wherein, when the IFrame is established, the kernel is provided with a public key of a public key-private key pair; and
the secure communication path from the kernel to the wrapper is provided by the kernel encrypting messages using the public key and broadcasting the encrypted messages.

14. The method according to claim 13, wherein the wrapper is arranged to receive the broadcast encrypted messages and forward the broadcast encrypted messages to the loader using the secure communication path from the wrapper to the loader.

15. The method according to claim 1, wherein elements provided to the computing device are provided through an interface.

16. The method according to claim 1, wherein the firewall is arranged to permit the event reporter to send communications through the kernel and to prevent the event reporter from sending communications by other routes.

17. The method according to claim 1, wherein the firewall is arranged to prevent the advertisement from sending communications.

18. The method according to claim 1, wherein the event reporter sends reporting messages to an event reporting server.

19. A computing device comprising a web browser and arranged to carry out a method of securely reporting events on the computing device comprising the steps of:
providing a loader to the computing device;
the loader providing a wrapper to the web browser for execution by the web browser, wherein the wrapper is a closure;
the loader establishing a secure communication path from the loader to the wrapper and a secure communication path from the wrapper to the loader;
the wrapper establishing an inline frame “IFrame” within the web browser, wherein the IFrame comprises a universal resource locator which points to a kernel;
establishing a firewall around the IFrame;
establishing a secure communication path from the wrapper to the kernel;
establishing a secure communication path from the kernel to the wrapper;
providing an event reporter to the IFrame through the loader, wrapper and kernel using the established secure communication paths from the loader to the wrapper and from the wrapper to the kernel; and
running the event reporter in the IFrame.

20. A tangible computer readable storage medium storing computer readable instructions for securely reporting events on a computing device comprising a web browser, which when executed by one or more processors, will cause the one or more processors to:
provide a loader to the computing device;
the loader providing a wrapper to the web browser for execution by the web browser, wherein the wrapper is a closure;
the loader establishing a secure communication path from the loader to the wrapper and a secure communication path from the wrapper to the loader;
the wrapper establishing an inline frame “IFrame” within the web browser, wherein the IFrame comprises a universal resource locator which points to a kernel;
establish a firewall around the IFrame;
establish a secure communication path from the wrapper to the kernel;
establish a secure communication path from the kernel to the wrapper;
provide an event reporter to the IFrame through the loader, wrapper and kernel using the established secure communication paths from the loader to the wrapper and from the wrapper to the kernel; and
run the event reporter in the IFrame.
